(19) United States
(12) Patent Application Publication
(10) Pub. No.: US 2025/0202009 A1
(43) Pub. Date: Jun. 19, 2025

(54) BATTERY PACK

(71) Applicants: Hyundai Motor Company, Seoul (KR); Kia Corporation, Seoul (KR)

(72) Inventors: Kyung Mo KIM, Hwaseong-Si (KR); Gun Woo Ko, Hwaseong-si (KR)

(73) Assignees: Hyundai Motor Company, Seoul (KR); Kia Corporation, Seoul (KR)

(21) Appl. No.: 18/920,262

(22) Filed: Oct. 18, 2024

(30) Foreign Application Priority Data
Dec. 13, 2023 (KR) 10-2023-0181276

(51) Int. Cl. H01M 50/242; H01M 50/211; H01M 50/262; H01M 50/271; H01M 50/293

(52) U.S. Cl. CPC H01M 50/242; H01M 50/211; H01M 50/262; H01M 50/271; H01M 50/293

(57) ABSTRACT

A battery pack includes a battery module, an end plate located on one side of the battery module in a first direction, that presses the battery module, and defining an extension space extending a second direction crossing the first direction in an interior thereof, and a reinforcement member extending in the second direction, and into which the extension space is inserted.

### CROSS-REFERENCE TO RELATED APPLICATION

The present application claims priority to Korean Patent Application No. 10-2023-0181276, filed on Dec. 13, 2023, the entire contents of which is incorporated herein for all purposes by this reference.

### BACKGROUND OF THE PRESENT DISCLOSURE

### Field of the Present Disclosure

The present disclosure relates to a battery pack.

### Description of Related art

Recently, as awareness of the crisis over the environment and depletion of oil resources has increased, research and development on electric vehicles that are eco-friendly vehicles has been highlighted. Electric vehicles (hereinafter referred to as “vehicles”) include plug-in hybrid electric vehicles (PHEVs), battery electric vehicles (BEVs), and fuel cell electric vehicles (FCEVs).

An electric vehicle may include a battery module, and a battery housing that supports the battery module. Meanwhile, an electric vehicle utilizes battery cells in a battery module as a power source, and the battery cells may include a swelling problem caused due to evaporation of electrolyte in the battery cells.

End plates that prevent swelling of battery cells may be provided on opposite sides of the battery module, and accordingly, a need for improved end plates is emerging.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a battery pack, in which a strength of end plates provided on opposite side surfaces of a battery module is improved.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a battery pack includes a battery module, an end plate located on one side of the battery module in a first direction, configured to press the battery module, and defining an extension space extending a second direction crossing the first direction in an interior of the end plate, and a reinforcement member extending in the second direction, and inserted into the extension space.

The end plate may include a cover end plate including a first side wall supporting one surface of the battery module, which faces the first direction, and a middle end plate including a second side wall supporting an opposite surface of the battery module, which faces an opposite direction to the first direction.

The cover end plate may define an upper extension space and a lower extension space spaced apart from each other in an upward and downward direction in an interior of the cover end plate.

The cover end plate may include an upper spacing wall spaced apart from the first side wall, and defining the upper extension space together with the first side wall, and a lower spacing wall spaced apart from the first side wall at a lower side of the upper spacing wall, and defining the lower extension space together with the first side wall.

The reinforcement member may include an upper reinforcement member inserted into the upper extension space, and configured to contact with the first side wall and the upper spacing wall, and a lower reinforcement member inserted into the lower extension space, and configured to contact with the first side wall and the lower spacing wall.

Each of the upper reinforcement member and the lower reinforcement member may include a first support portion supporting the first side wall, a second support portion supporting the upper spacing wall or the lower spacing wall, a third support portion supporting the first side wall at a lower side of the first support portion, a first connecting portion connecting the first support portion and the second support, and a second connecting portion connecting the second support portion and the third support portion.

The middle end plate may define a middle extension space provided between heights of the upper extension space and the lower extension space in an interior of the middle end plate.

The middle end plate may further include a middle spacing wall spaced apart from the second side wall, and defining the middle extension space together with the second side wall.

The reinforcement member may include a middle reinforcement member inserted into the middle extension space, and configured to contact with the second side wall and the middle spacing wall.

The middle reinforcement member may include a first middle support portion supporting the second side wall, a second middle support portion supporting the middle spacing wall, a third middle support portion supporting the second side wall at a lower side of the first middle support portion, a first middle connecting portion connecting the first middle support portion and the second middle support portion, and a second middle connecting portion connecting the second middle support portion and the third middle support portion.

The battery pack may further include a base plate supporting the battery module, and defining a first fastening hole for fixing the middle end plate and a second fastening hole for fixing the cover end plate, and a fastening member configured to fix the cover end plate and the middle end plate, and insert into the first fastening hole and the second fastening hole.

The cover end plate may define a cover hole configured so that the fastening member is inserted thereinto, and configured at a position corresponding to the second fastening hole when viewed from a top, and the middle end plate may define a middle hole configured so that the fastening member is inserted thereinto, and formed at a position corresponding to the first fastening hole when viewed from a top.

The cover end plate may further include upper protruding walls protruding from an upper end and a lower end of the upper spacing wall, respectively, to extend to the first side wall, and defining the upper extension space together with the first side wall and the upper spacing wall, and lower protruding walls spaced downward from the upper protruding walls, protruding from an upper end and a lower end of the lower spacing wall to extend to the first side wall, and defining the lower extension space together with the first side wall and the lower spacing wall, the cover hole may include an upper cover hole formed in the upper protruding wall, and a lower cover hole formed in the lower protruding wall, and a size of the upper cover hole may be configured to be greater than a size of the lower cover hole when viewed from a top.

The reinforcement member may include an upper reinforcement member inserted into the upper extension space, and a lower reinforcement member inserted into the lower extension space, and the upper reinforcement member and the lower reinforcement member may define an upper reinforcing hole and a lower reinforcing hole configured to correspond to positions of the upper cover hole and the lower cover hole, and through which the fastening member passes, respectively.

The middle end plate may further include middle protruding walls protruding from an upper end and a lower end of the middle spacing wall, extending to the second side wall, and defining a middle extension space together with the second side wall and the middle spacing wall, and the middle hole may be formed in the middle protruding walls.

The reinforcement member may include a middle reinforcement member inserted into the middle extension space, and the middle reinforcement member may define a middle reinforcing hole configured to correspond to a position of the middle hole, and through which the fastening member passes.

A thickness of the reinforcement member may be configured to be smaller than a thickness of the end plate when viewed in the second direction thereof.

The end plate may be formed of aluminum, and the reinforcement member may be formed of steel.

The battery module may include a first battery module, and a second battery module spaced apart from the first battery module in the first direction, the end plate may include a cover end plate including a first side wall supporting one surface of the first battery module, which faces the second battery module, and an upper spacing wall spaced apart from the first side wall and defining an upper extension space with the first side wall and a lower spacing wall spaced apart from the first side wall and defining a lower extension space spaced apart with the first side wall, wherein the upper extension space and the lower extension space are spaced apart from each other in an upward and downward direction in an interior of the batter pack, and a middle end plate including a second side wall supporting one surface of the second battery module, which faces the first battery module, and a middle spacing wall spaced apart from the second side wall and defining a middle extension space between the upper extension space and the lower extension space with the second side wall, and the middle spacing wall may be disposed to be inserted between the upper spacing wall and the lower spacing wall.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a perspective view of a battery pack according to an exemplary embodiment of the present disclosure;

FIG. 2 is an exploded perspective view of a battery pack according to an exemplary embodiment of the present disclosure;

FIG. 3 is a perspective view of a battery module provided with a cover end plate and a middle end plate according to an exemplary embodiment of the present disclosure;

FIG. 4 is a side view of a battery module provided with a cover end plate and a middle end plate according to an exemplary embodiment of the present disclosure;

FIG. 5 is an enlarged view of a cover end plate, an upper reinforcement member, and a lower reinforcement member illustrated in FIG. 4;

FIG. 6 is an enlarged view of a middle reinforcement member of a middle end plate illustrated in FIG. 4;

FIG. 7 is a side view exemplarily illustrating an arrangement of a plurality of battery modules according to an exemplary embodiment of the present disclosure;

FIG. 8 is a view exemplarily illustrating a cover end plate before an upper reinforcement member and a lower reinforcement member are inserted into the cover end plate, according to an exemplary embodiment of the present disclosure;

FIG. 9 is a view exemplarily illustrating a middle end plate before a middle reinforcement member is inserted into the middle end plate, according to an exemplary embodiment of the present disclosure;

FIG. 10 is a schematic view of a battery module inserted between a cover end plate and a middle end plate mounted on a base plate according to an exemplary embodiment of the present disclosure; and

FIG. 11 is a schematic view of a battery module fixed to a transverse support member according to another exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the appended drawings so that those skilled in the art may easily implement the present disclosure. When adding reference numerals to components in each drawing, it should be noted that identical components are provided the same reference numerals as much as possible even if they are shown in different drawings. Additionally, in describing embodiments of the present disclosure, when it is determined that detailed descriptions of related known configurations or functions may impede understanding of the exemplary embodiments of the present disclosure, detailed descriptions thereof will be omitted.

Furthermore, in describing the components of the exemplary embodiments of the present disclosure, terms, such as first, second, “A”, “B”, (a), and (b) may be used. The terms are simply for distinguishing the components, and the essence, the sequence, and the order of the corresponding components are not limited by the terms. Unless defined differently, all the terms including technical or scientific terms include the same meanings as those generally understood by an ordinary person in the art, to which the present disclosure pertains. The terms, such as the terms defined in dictionaries, which are generally used, should be construed to coincide with the context meanings of the related technologies, and are not construed as ideal or excessively formal meanings unless explicitly defined in an exemplary embodiment of the present disclosure.

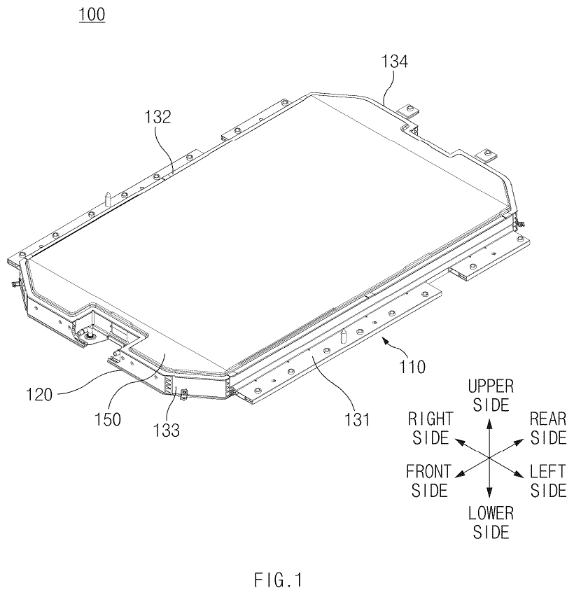

Hereinafter, various exemplary embodiments of the present disclosure will be described in detail with reference to FIGS. 1 to 11.

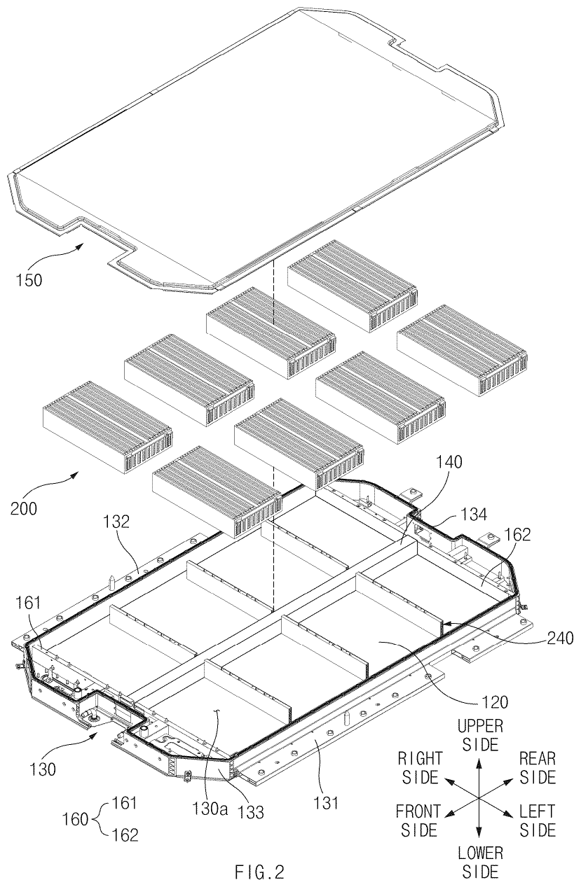

FIG. 1 is a perspective view of a battery pack according to an exemplary embodiment of the present disclosure. FIG. 2 is an exploded perspective view of the battery pack according to an exemplary embodiment of the present disclosure.

Referring to FIG. 1 and FIG. 2, a battery pack 100 may be a component which is mounted in an interior of an electric vehicle to transmit power of the electric vehicle. The battery pack 100 may include a battery module 200, and a battery pack housing 110 that covers the battery module 200.

The battery module 200 may include a plurality of battery cells. The battery cell may be a lithium-ion battery, but the present disclosure is not limited thereto. The plurality of battery cells may be used in a form of a battery module to be protected from an external shock, heat, vibration, and the like or to provide high electric power. The plurality of battery modules 200 may be supported by the battery pack housing 110 while being spaced apart from each other in a forward/rearward direction or a leftward/rightward direction thereof.

The battery pack housing 110 may include a base plate 120 which is disposed at a lower side of the battery module 200 and supports the battery module 200, and a side member 130 which is supported by the base plate 120 and extends along a circumference of the base plate 120. The battery pack housing 110 may further include a pack cover 150 which is coupled to the side member 130 and covers an upper side of the battery module 200.

The base plate 120 may be formed in a substantially rectangular shape so that a forward/rearward direction is a longitudinal direction thereof. The side member 130 may be coupled to the base plate 120 along a circumference of the base plate 120 to cover front, rear, left and right sides of the battery module 200.

The side member 130 may include a first side member 131 that extends in a first direction that faces a rear side to cover the left side of the battery module 200, and a second side member 132 which is provided in parallel to the first side member 131 to cover the right side of the battery module 200. The side member 130 may include a third side member 133 that connects the first side member 131 and the second side member 132 to cover the front side of the battery module 200, and a fourth side member 134 which is provided in parallel to the third side member 133 to cover the rear side of the battery module 200.

A module accommodating space 130a may be defined between the first, second, third and fourth side members 131, 132, 133, and 134. The module accommodating space 130a may be a space for accommodating the plurality of battery modules 200.

The battery pack housing 100 may include a longitudinal support member 140 which is supported by the base plate 120 and connects the third side member 133 and the fourth side member 134. The longitudinal support member 140 may extend from a central area of the base plate 120 in a first direction thereof.

The battery pack housing 100 may further include a transverse support member 160 which is supported by the base plate 120 and extends in a second direction that crosses the first direction (an example: the leftward direction). The transverse support member 160 may include a first transverse support member 161 which is adjacent to the third side member 133, and a second transverse support member 162 which is adjacent to the fourth side member 134.

An end plates 240 may be provided between the first transverse support member 161 and the second transverse support member 162 instead of a separate transverse member which is supported by the base plate 120. The end plates 240 may extend in the second direction between the first transverse support member 161 and the second transverse support member 162 and may be disposed in parallel to each other along the first direction. Furthermore, the end plates 240 may be disposed at corresponding positions on the left and right sides of the longitudinal support member 140.

The end plates 240 may support one surface or opposite surfaces of the battery module 200 in the first direction. The end plates 240 and the longitudinal support member 140 may partition the module accommodating spaces 130a defined by side members 130. Accordingly, the plurality of battery modules 200 may be accommodated in the module accommodating spaces 130a.

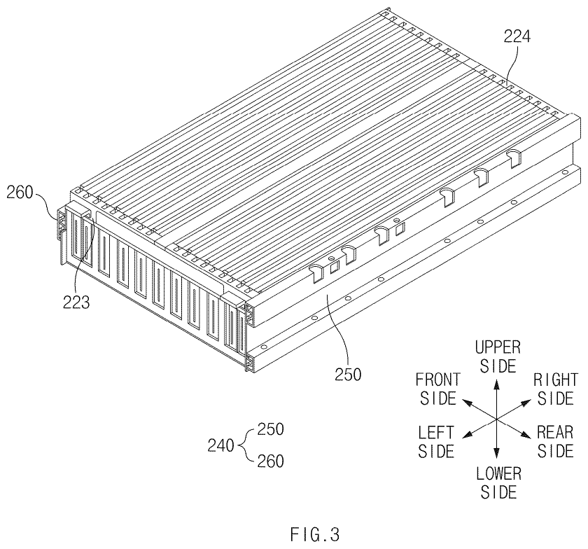

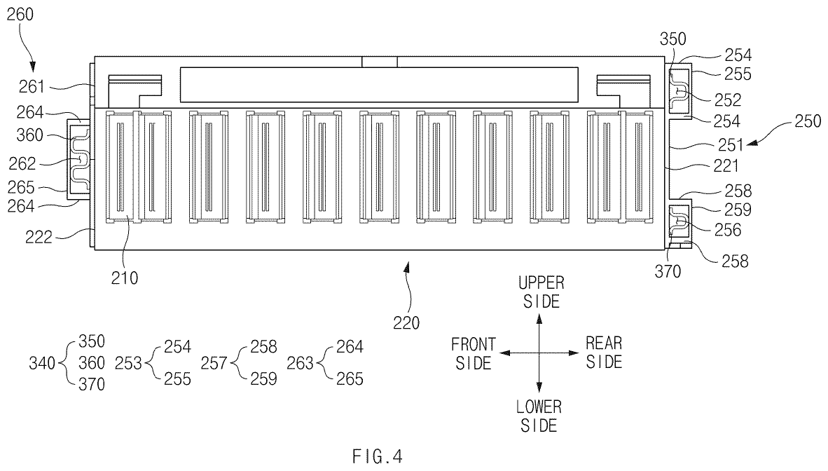

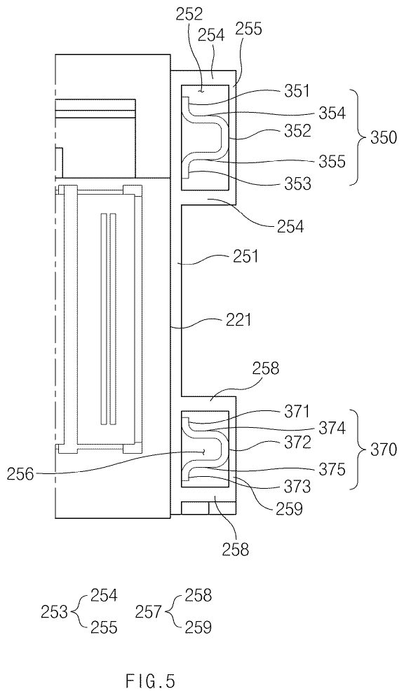

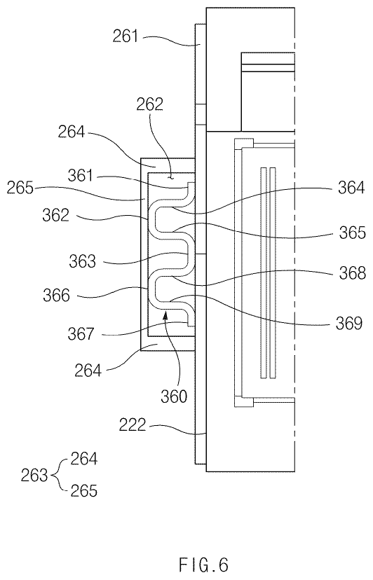

Hereinafter, the battery module 200 according to an exemplary embodiment of the present disclosure will be described in detail with reference to FIG. 3, FIG. 4, FIG. 5 and FIG. 6.

FIG. 3 is a perspective view of a battery module provided with the cover end plate and the middle end plate according to an exemplary embodiment of the present disclosure. FIG. 4 is a side view of the battery module provided with the cover end plate and the middle end plate according to an exemplary embodiment of the present disclosure. FIG. 5 is an enlarged view of the cover end plate, the upper reinforcement member, and the lower reinforcement member illustrated in FIG. 4. FIG. 6 is an enlarged view of the middle reinforcement member of the middle end plate illustrated in FIG. 4.

Referring to FIG. 3, FIG. 4, FIG. 5 and FIG. 6, the battery module 200 may further include the plurality of battery cells that extend in the longitudinal direction thereof. The plurality of battery cells may be disposed in parallel to each other in the forward/rearward direction thereof.

The battery module 200 may further include a module housing 220 that covers the plurality of battery cells. The module housing 220 may include a first side surface 221 that faces the first direction (an example: the rearward direction) of the plurality of battery cells, and a second side surface 222 that faces an opposite direction (an example: the forward direction) to the first direction of the plurality of battery cells. The first side surface 221 and the second side surface 222 of the module housing 220 may face opposite directions, and the first side surface 221 and the second side surface 222 may be referred to as one surface 221 and an opposite surface 222 of the battery module 200.

The module housing 220 may include a third side surface 223 that connects the first side surface 221 and the second side surface 222 and covers a left side of the plurality of battery cells, and a fourth side surface 224 which is disposed in parallel to the third side surface 223 and covers a right side of the plurality of battery cells.

The battery pack 100 (see FIG. 1) may include an end plates 240 which is disposed on a side of the battery module 200 in the first direction (an example: the rearward direction) and in an opposite direction (an example: the forward direction) to the first direction.

The structure illustrated in FIG. 3, FIG. 4, FIG. 5 and FIG. 6 is for convenience only, and the battery module 200 is not inserted into the module accommodating space 130a (see FIG. 2) while being coupled to the end plates 240. As described above, it may be understood that the battery module 200 is inserted into the module accommodating space 130a after the end plates 240 is coupled to the base plate 120.

The end plates 240 may be disposed on the first side surface 221 and the second side surface 222 of the battery module 200 to prevent the plurality of battery cells from swelling by pressing the battery module 200. The end plates 240 may extend in a second direction (an example: the leftward direction) which is the longitudinal direction of the battery module 200. The second direction may be a direction that crosses the first direction, and in more detail, may be a direction which is perpendicular to the first direction.

The end plates 240 may include a cover end plate 250 which is configured to support the first side surface 221 of the battery module 200, and a middle end plate 260 which is configured to support the second side surface 222 of the battery module 200.

The cover end plates 250 and the middle end plates 260 may be configured to press the first side surfaces 221 and the second side surfaces 222 of the battery modules 200, respectively. The cover end plate 250 may include a first side wall 251 that supports the first side surface 221 of the battery module 200, and the middle end plate 260 may include a second side wall 261 that supports the second side surface 222 of the battery module 200. The first side wall 251 and the second side wall 261 may be disposed in parallel to each other.

In the present way, the cover end plate 250 and the middle end plate 260 may extend in parallel to each other in the second direction of the battery module 200. Both of the cover end plate 250 and the middle end plate 260 may be extruded in the second direction to be manufactured. Both of the cover end plate 250 and the middle end plate 260 may be formed of aluminum (Al).

Each of the cover end plate 250 and the middle end plate 260 may define an extension space 252, 256, and 262 that extend in the second direction thereof. In more detail, the cover end plate 250 may define an upper extension space 252 and a lower extension space 256 that are spaced apart from each other in an upward and downward direction in an interior thereof. Furthermore, the middle end plate 260 may define a middle extension space 262 which is provided between heights of the upper extension space 252 and the lower extension space 256, in an interior thereof.

The cover end plate 250 may include a first side wall 251 that extends in the upward and downward direction, and an upper protrusion 253 that extends from the first side wall 251 to define the upper extension space 252 together with the first side wall 251.

The upper protrusion 253 may include an upper spacing wall 255 which is spaced apart from the first side wall 251 and defines an upper extension space 252 together with the first side wall 251, and an upper protruding wall 254 that protrudes from an upper end and a lower end of the upper spacing wall 255 to extend to the first side wall 251 and defines an upper extension space 252 together with the first side wall 251 and the upper spacing wall 255. The upper spacing wall 255 may be disposed in parallel to the first side wall 251, and the upper spacing wall 255 and the first side wall 251 may be connected to each other by the upper protruding wall 254.

The cover end plate 250 may include a lower protrusion 257 that extends from the first side wall 251 at a lower side of the upper protrusion 253 and defines a lower extension space 256 together with the first side wall 251.

The lower protrusion 257 may include a lower spacing wall 259 which is spaced apart from the first side wall 251 at a lower side of the upper spacing wall 255 and defines a lower extension space 256 together with the first side wall 251, and lower protruding walls 258 that are spaced downward apart from the upper protruding wall 254, protrude from an upper end and a lower end of the lower spacing wall 259, respectively, extend to the first side wall 251, and define a lower extension space 256 together with the first side wall 251 and the lower spacing wall 259. The lower spacing wall 259 may be disposed in parallel to the first side wall 251, and the lower spacing wall 259 and the first side wall 251 may be connected to each other by a lower protruding wall 258.

Meanwhile, the middle end plate 260 may include a second side wall 261 which is disposed in parallel to the first side wall 251, and a middle protrusion 263 that extends from the second side wall 261 to define a middle extension space 262 together with the second side wall 261.

The middle protrusion 263 may include a middle spacing wall 265 which is spaced apart from the second side wall 261 and defines a middle extension space 262 together with the second side wall 261, and middle protruding walls 264 that protrude from an upper end and a lower end of the middle spacing wall 265, extend to the second side wall 261, and defines the middle extension space 262 together with the second side wall 261 and the middle spacing wall 265. The middle spacing wall 265 may be disposed in parallel to the second side wall 261, and the middle spacing wall 265 and the second side wall 261 may be connected to each other by the middle protruding wall 264.

According to the present structure, all of the upper extension space 252 and the lower extension space 256 of the cover end plate 250, and the middle extension space 262 of the middle end plate 260 may extend in the second direction thereof. Meanwhile, a durability of the cover end plate 250 and the middle end plate 260 may be weakened over time as the battery module 200 is pressed.

To prevent the present problem, the battery pack 100 according to an exemplary embodiment of the present disclosure may further include a reinforcement member 340 that extends in the second direction and is inserted into the extension space 252, 256, and 262.

The reinforcement member 340 may be formed of steel. When viewed from the second direction, a thickness of the reinforcement member 340 may be smaller than thicknesses of the cover end plate 250 and the middle end plate 260. In other words, the thickness of the reinforcement member 340 may be approximately half of the thickness of the end plates 240.

The reinforcement member 340 may include an upper reinforcement member 350 which is inserted into the upper extension space 252, a middle reinforcement member 360 which is inserted into the middle extension space 262, and a lower reinforcement member 370 which is inserted into the lower extension space 256.

The upper reinforcement member 350 may be a component which is inserted into the upper extension space 252 to reinforce an upper portion of the cover end plate 250. The upper reinforcement member 350 may be configured to contact with the first side wall 251 and the upper spacing wall 255.

In more detail, the upper reinforcement member 350 may include a first support portion 351 that supports the first side wall 251, a second support portion 352 that supports the upper spacing wall 255, and a third support portion 353 that supports the first side wall 251 at a lower side of the support portion 351. The upper reinforcement member 350 may include a first connecting portion 354 that connects the first support portion 351 and the second support portion 352, and a second connecting portion 355 that connects the second support portion 352 and the third support portion 353. It may be understood that the upper reinforcement member 350 includes a substantially wave-shaped cross section.

The lower reinforcement member 370 may be a component which is inserted into the lower extension space 256 to reinforce a lower portion of the cover end plate 250. The lower reinforcement member 370 may be configured to contact with the first side wall 251 and the lower spacing wall 259.

Furthermore, the lower reinforcement member 370 may include a first support portion 371 that supports the first side wall 251, a second support portion 372 that supporting the lower spacing wall 259, and a third support portion 373 that supports the first side wall 251 at a lower side of the first support portion 371. The lower reinforcement member 370 may include a first connecting portion 374 that connects the first support portion 371 and the second support portion 372, and a second connecting portion 375 that connects the second support portion 372 and the third support portion 373. It may be understood that the lower reinforcement member 370 includes a substantially wave-shaped cross section.

According to the present structure, the upper reinforcement member 350 may be inserted into the upper extension space 252 to support the first side wall 251 and the upper spacing wall 255, and the lower reinforcement member 370 may be inserted into the lower extension space 252 to support the first side wall 251 and the lower spacing wall 259. Accordingly, a strength of the cover end plate 250 at an upper portion and a lower portion thereof may be improved.

Similarly, the middle reinforcement member 360 may a component which is inserted into the middle extension space 262 to reinforce the middle end plate 260. The middle reinforcement member 360 may be configured to contact with the second side wall 261 and the middle spacing wall 265.

The middle reinforcement member 360 includes a first middle support portion 361 that supports the second side wall 261, a second middle support portion 362 that supports the middle spacing wall 265, and a third middle support portion 363 that supports the second side wall 261 at a lower side of the first middle support portion 361. The middle reinforcement member 360 may include a fourth middle support portion 366 that supports the middle spacing wall 265 at a lower side of the second middle support portion 362, and a fifth middle support portion 367 that supports the second side wall 261 at a lower side of the third middle support portion 363.

The middle reinforcement member 360 may include a first middle connecting portion 364 that connects the first middle support portion 361 and the second middle support portion 362, a second middle connecting portion 365 that connects the second middle support portion 362 and the third middle support portion 363, a third middle connecting portion 368 that connects the third middle support portion 363 and the fourth middle support portion 366, and a fourth middle connecting portion 369 that connects the fourth middle support portion 366 and the fifth middle support portion 367. It may be understood that the middle reinforcement member 360 includes a substantially wave-shaped cross section.

The middle reinforcement member 360 may be longer in the upward and downward direction than the upper reinforcement member 350 or the lower reinforcement member 370, and may support the second side wall 261 at three sites and may supports the middle spacing wall 265 at two sites. This may be because a length of the middle accommodation space 262 in the upward and downward direction is longer than a length of the upper extension space 252 or the lower extension space 256 in the upward and downward direction thereof.

According to the present structure, the middle reinforcement member 360 may be inserted into the middle accommodation space 262 to improve a strength of the middle end plate 260.

That is, a strength of the cover end plate 250 may be improved by the upper reinforcement member 350 and the lower reinforcement member 370 and a strength of the middle end plate 260 may be improved by the middle reinforcement member 360 whereby a force applied to the first side surface 221 and the second side surface 222 of the battery module 200 may be increased and a durability of the cover end plate 250 and the middle end plate 260 may be improved.

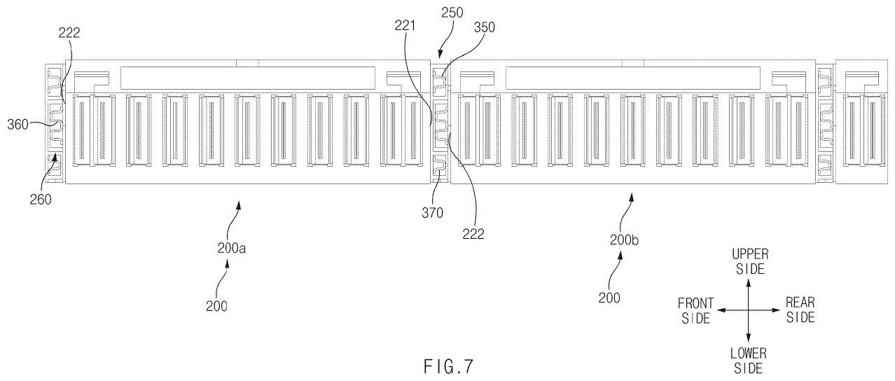

FIG. 7 is a side view exemplarily illustrating an arrangement of the plurality of battery modules according to an exemplary embodiment of the present disclosure.

Referring to FIG. 7, the plurality of battery modules 200 may be disposed in the first direction (an example: the rearward direction). The plurality of battery modules 200 may be disposed between two adjacent battery modules 200 to be spaced apart therefrom. The plurality of battery modules 200 may include a first battery module 200a, and a second battery module 200b which is disposed at a side of the first battery module 200a in the first direction.

A cover end plate 250 may be provided on the first side surface 221 of the first battery module 200a, which faces the second battery module 200b. A middle end plate 260 may be provided on the second side surface 222 of the second battery module 200b, which faces the first battery module 200a. Here, the shapes of the cover end plate 250 and the middle end plate 260 is the same as the structures described above.

The middle protrusion 263 (see FIG. 6) of the middle end plate 260 may be inserted into a space between the upper protrusion 253 (see FIG. 5) and the lower protrusion 257 of the cover end plate 250. In other words, the middle spacing wall 265 of the middle end plate 260 may be inserted through and disposed in a gap which is provided between the upper spacing wall 255 and the lower spacing wall 259 of the cover end plate 250.

According to the present structure, the cover end plate 250 provided on the first side surface 221 of the first battery module 200a, which faces the second battery module 200b, may press the second battery module 200b in the first direction, and may press the first battery module 200a in an opposite direction to the first direction.

Furthermore, the middle end plate 260 provided on the second side surface 222 of the second battery module 200b, which faces the first battery module 200a, may press the first battery module 200a in an opposite direction to the first direction, and may press the second battery module 200b in the first direction.

Meanwhile, the separate transverse member provided in the interior of the battery pack housing 110 (see FIG. 1) may not be provided between two adjacent battery modules 200.

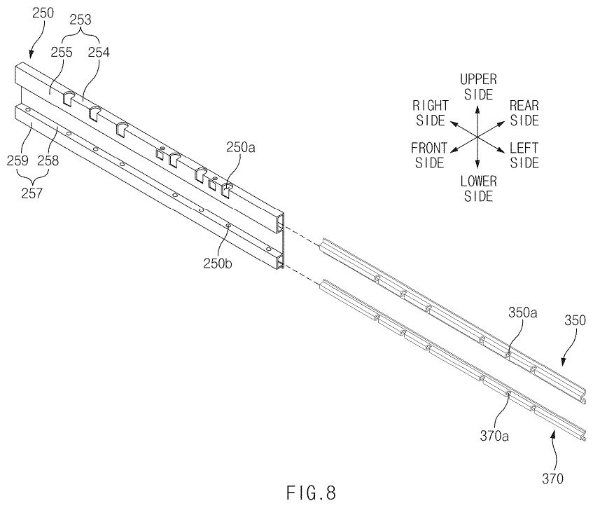

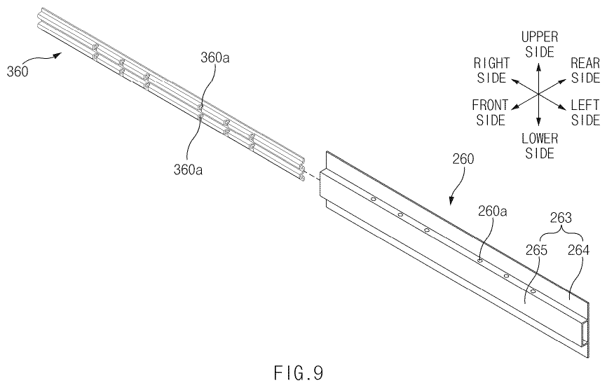

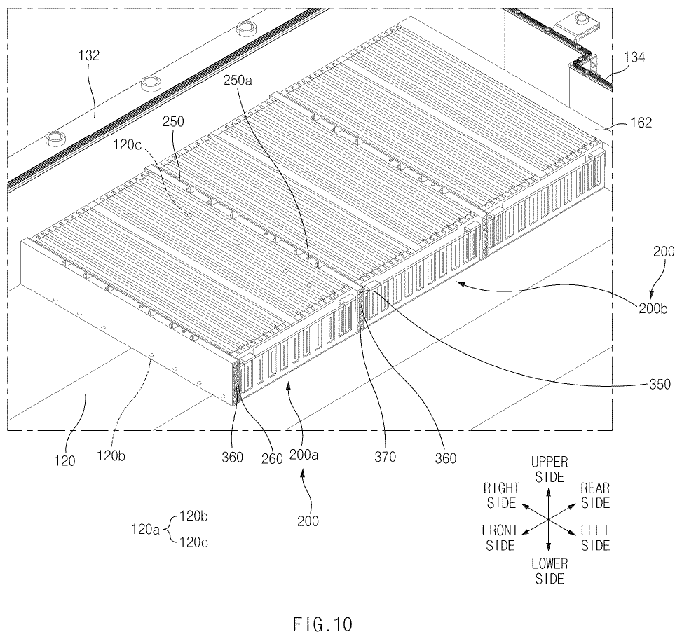

FIG. 8 is a view exemplarily illustrating the cover end plate before the upper reinforcement member and the lower reinforcement member are inserted into the cover end plate, according to an exemplary embodiment of the present disclosure. FIG. 9 is a view exemplarily illustrating the middle end plate before the middle reinforcement member is inserted into the middle end plate, according to an exemplary embodiment of the present disclosure. FIG. 10 is a schematic view of the battery module inserted between the cover end plate and the middle end plate mounted on the base plate according to an exemplary embodiment of the present disclosure.

Referring to FIG. 8, FIG. 9 and FIG. 10, the cover end plate 250 may define cover holes 250a and 250b. The cover holes 250a and 250b may include an upper cover hole 250a which is formed in the upper protrusion 253 and a lower cover hole 250b which is formed in the lower protruding wall 258.

The upper cover hole 250a may be formed in the upper protruding wall 254 and the upper spacing wall 255 of the upper protrusion 253. The upper cover hole 250a may be configured to fluidically-communicate with the upper protruding wall 254 and the upper spacing wall 255, and may be formed in the upper protruding wall 254 and the upper spacing wall 255, respectively. A plurality of upper cover holes 250a may be provided to be spaced apart from each other along the second direction (an example: the leftward direction).

The lower cover hole 250b may be formed in the lower protruding wall 258. The lower cover holes 250b may be formed in the lower protruding wall 258 and the lower spacing wall 259. A plurality of lower cover holes 250b may be provided to correspond to positions of the upper cover holes 250a along the second direction (an example: the leftward direction).

The upper cover hole 250a may be a portion, into which a head portion of a fastening member is inserted. The lower cover hole 250b may be a portion, into which a screw thread of a fastening member is inserted. Accordingly, when viewed from the top, a size of the upper cover hole 250a may be greater than a size of the lower cover hole 250b. The upper reinforcement member 350 may include an upper reinforcing hole 350a, through which the fastening member passes as it is inserted into the cover end plate 250. The lower reinforcement member 370 may include a lower reinforcing hole 370a, through which the fastening member passes as it is inserted into the cover end plate 250. The upper reinforcing hole 350a and the lower reinforcing hole 370a may be provided to correspond to positions of the upper cover hole 250a and the lower cover hole 250b, respectively.

The middle end plate 260 may define a middle hole 260a. The middle hole 260a may be formed in the middle protruding wall 264 of the middle protrusion 263. The middle hole 260a may be provided to correspond to the positions of the upper cover hole 250a and the lower cover hole 250b between the upper cover hole 250a and the lower cover hole 250b provided to corresponding positions of the cover end plate 250. A plurality of middle holes 260a may also be provided to be spaced apart from each other along the second direction, and may be configured so that the fastening member is inserted thereinto.

The middle reinforcement member 360 may be inserted into the middle end plate 260 to define a middle reinforcing hole 360a, through which the fastening member passes. When viewed from a top, the middle reinforcing hole 360a may be configured to correspond to the position of the middle hole 260a.

However, components, such as stud bolts, may be inserted into the upper cover hole 250a, the lower cover hole 250b, and the middle hole 260a instead of components, such as screws. Furthermore, instead of forming structures of the upper cover hole 250a, the lower cover hole 250b, and the middle hole 260a, the cover end plate 250 and middle end plate 260 may be welded to or press-fitted with the base plate 120.

Meanwhile, the base plate 120 may define a fastening hole 120a for fixing the cover end plate 250 and the middle end plate 260. The fastening holes 120a may be configured to be spaced apart from each other in a row along the second direction (an example: the leftward direction) of the base plate 120.

The fastening hole 120a may include a first fastening hole 120b for fixing the middle end plate 260 provided on the second side surface 222 (see FIG. 7) of the first battery module 200a, and a second fastening hole 120c for fixing the cover end plate 250 provided on the first side surface 221 of the first battery module 200a.

The second fastening hole 120c may be a hole for fixing the cover end plate 250 of the first battery module 200a and the middle end plate 260 provided on the second side surface 222 of the second battery module 200b, which faces the first battery module 200a.

The second fastening hole 120c may be disposed on a side of the first fastening hole 120b in the first direction (an example: the rearward direction). The battery pack 100 (see FIG. 1) may include fastening members that are configured to fix the cover end plate 250 and the middle end plate 260, respectively, and are inserted into the first fastening hole 120b and the second fastening hole 120c, respectively.

According to the present structure, the upper cover hole 250a formed in the cover end plate 250 of the first battery module 200a may be formed at a position corresponding to the second fastening hole 120c when viewed from a top. Furthermore, the middle hole 260a formed in the middle end plate 260 of the first battery module 200a may be formed at a position corresponding to the first fastening hole 120b when viewed from a top.

To achieve the present structure, the base plate 120 may be an extruded member. In other words, the base plate 120 may be formed of an extruded member to facilitate insertion of the fastening member.

In the present way, the plurality of battery modules 200 may simultaneously pass through the cover end plate 250 and the middle end plate 260 without a separate transverse member of the battery pack 100, and may be fixed attached to the fastening member fixed to the base plate 120. According to the present structure, a density of battery modules 200 provided in a limited battery pack 100 (see FIG. 1) may be increased.

Furthermore, instead of a configuration of the transverse support member 160 illustrated in FIG. 2, a front surface of, the plurality of battery modules 200, in which the end plates 240 are formed, and that are disposed in the first direction, the battery module 200 disposed at a front side, and a rear surface of the battery module 200 disposed at a rear side may be supported by the end plates 240.

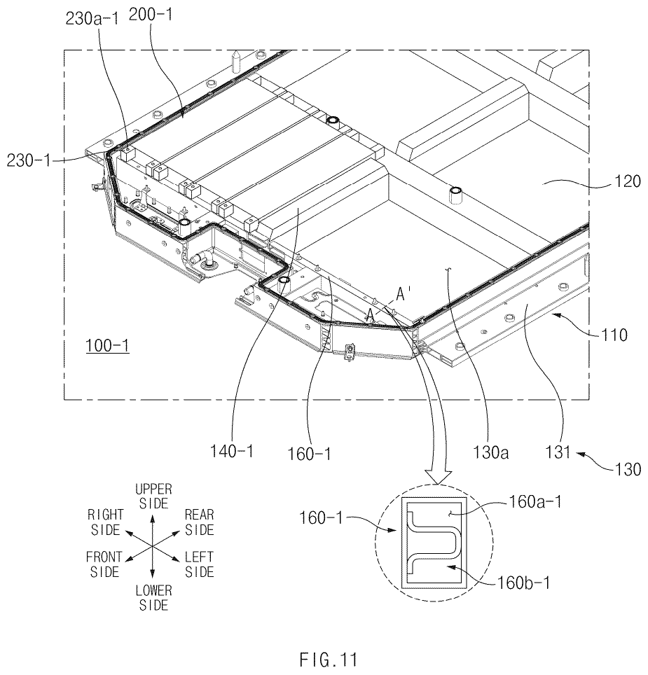

FIG. 11 is a schematic view of the battery module fixed to the transverse support member according to another exemplary embodiment of the present disclosure.

Referring to FIG. 11, the battery module 200-1 may be supported by the base plate 120. The side member 130 that extends along a circumference of the base plate 120 may be coupled to front, rear, left and right edge portions of the base plate 120.

The side member 130 may define a module accommodating space 130a in an interior thereof. The module accommodating space 130a may be a space for accommodating the battery module 200-1. The module accommodating space 130a may be partitioned by the longitudinal support member 140-1 that extends in the first direction (an example: the rearward direction) and the transverse support member 160-1 that extends in the second direction (an example: the leftward direction) which is perpendicular to the first direction. A plurality of battery modules 200-1 may be accommodated in each partitioned module accommodating space 130a.

Meanwhile, according to the present structure, the battery module 200-1 may be provided so that the second direction is a longitudinal direction thereof, and the battery module 200-1 may be fixed to the transverse support member 160-1 by the flange portion 230-1 that protrudes from the battery module 200-1 in the second direction or an opposite direction to the second direction thereof.

Accordingly, the base plate 120 may be disposed at a lower side of the transverse support member 160-1, and the flange portion 230-1 may be provided at an upper side of the transverse support member 160-1. A flange hole 230a-1 may be provided in the flange portion 230-1. The battery module 200-1 may be fixed to an interior of the battery pack housing 110 by the fastening member that passes through the flange hole 230a-1.

Meanwhile, the transverse support member 160-1 may define a transverse member space 160a-1 that extends in the second direction in an interior thereof. Because the transverse support member 160-1 may also be configured to press the battery module 200-1, a strength of the transverse support member 160-1 may be improved by a transverse reinforcement member 160b-1 which is inserted into the transverse member space 160a-1. Due to a structure of the transverse reinforcement member 160b-1, the transverse support member 160-1 may support the battery module 200-1 with a stronger force, and thus, even in the battery pack according to another exemplary embodiment of the present disclosure, swelling of the battery module 200-1 may be prevented.

Furthermore, the present structure is not limited thereto, and a longitudinal reinforcement member is also inserted into an interior of the longitudinal support member 140-1, and thus a strength of the longitudinal support member 140-1 may also be improved.

According to the present technology, because the reinforcement member is inserted into accommodation spaces of the end plates provided on opposite side surfaces of the battery module, the strength of the end plates may be improved and thus, and effectively preventing swelling of battery cells may be effectively prevented.

Furthermore, according to the present technology, the end plates provided on opposite side surfaces of the battery module may be directly coupled to the base plate, and thus, the density of the battery modules provided in the battery pack may be improved.

Furthermore, according to the present technology, the cover end plate provided on opposite side surfaces of the battery module and the middle end plate are engaged with each other, and thus, the density of the battery modules provided in the battery pack may be improved and a structural stability of the battery modules may be improved.

Furthermore, various effects which may be directly or indirectly recognized through the present disclosure may be provided.

The above description is a simple exemplary description of the technical spirits of the present disclosure, and an ordinary person in the art, to which the present disclosure pertains, may make various corrections and modifications without departing from the essential characteristics of the present disclosure.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A battery pack comprising:
a battery module;
an end plate located on one side of the battery module in a first direction, configured to press the battery module, and defining an extension space extending a second direction crossing the first direction in an interior of the end plate; and
a reinforcement member extending in the second direction, and inserted into the extension space.

2. The battery pack of claim 1, wherein the end plate includes:
a cover end plate including a first side wall supporting one surface of the battery module, which faces the first direction; and
a middle end plate including a second side wall supporting an opposite surface of the battery module, which faces an opposite direction to the first direction.

3. The battery pack of claim 2, wherein the cover end plate defines an upper extension space and a lower extension space spaced apart from each other in an upward and downward direction in the interior of the cover end plate

4. The battery pack of claim 3, wherein the cover end plate includes:
an upper spacing wall spaced apart from the first side wall, and defining the upper extension space together with the first side wall; and
a lower spacing wall spaced apart from the first side wall at a lower side of the upper spacing wall, and defining the lower extension space together with the first side wall.

5. The battery pack of claim 4, wherein the reinforcement member includes:
an upper reinforcement member inserted into the upper extension space, and configured to contact with the first side wall and the upper spacing wall; and
a lower reinforcement member inserted into the lower extension space, and configured to contact with the first side wall and the lower spacing wall.

6. The battery pack of claim 5, wherein each of the upper reinforcement member and the lower reinforcement member includes:
a first support portion supporting the first side wall;
a second support portion supporting the upper spacing wall or the lower spacing wall;
a third support portion supporting the first side wall at a lower side of the first support portion;
a first connecting portion connecting the first support portion and the second support; and
a second connecting portion connecting the second support portion and the third support portion.

7. The battery pack of claim 4, wherein the middle end plate defines a middle extension space provided between heights of the upper extension space and the lower extension space in an interior of the middle end plate.

8. The battery pack of claim 7, wherein the middle end plate further includes:
a middle spacing wall spaced apart from the second side wall, and defining the middle extension space together with the second side wall.

9. The battery pack of claim 8, wherein the reinforcement member includes:
a middle reinforcement member inserted into the middle extension space, and configured to contact with the second side wall and the middle spacing wall.

10. The battery pack of claim 9, wherein the middle reinforcement member includes:
a first middle support portion supporting the second side wall;
a second middle support portion supporting the middle spacing wall;
a third middle support portion supporting the second side wall at a lower side of the first middle support portion;
a first middle connecting portion connecting the first middle support portion and the second middle support portion; and
a second middle connecting portion connecting the second middle support portion and the third middle support portion.

11. The battery pack of claim 8, further including:
a base plate supporting the battery module, and defining a first fastening hole for fixing the middle end plate and a second fastening hole for fixing the cover end plate; and
a fastening member configured to fix the cover end plate and the middle end plate, and insert into the first fastening hole and the second fastening hole.

12. The battery pack of claim 11,
wherein the cover end plate defines a cover hole configured so that the fastening member is inserted thereinto, and configured at a position corresponding to the second fastening hole when viewed from a top, and
wherein the middle end plate defines a middle hole configured so that the fastening member is inserted thereinto, and formed at a position corresponding to the first fastening hole when viewed from a top.

13. The battery pack of claim 12,
wherein the cover end plate further includes:
upper protruding walls protruding from an upper end and a lower end of the upper spacing wall, respectively, to extend to the first side wall, and defining the upper extension space together with the first side wall and the upper spacing wall; and
lower protruding walls spaced downward from the upper protruding walls, protruding from an upper end and a lower end of the lower spacing wall to extend to the first side wall, and defining the lower extension space together with the first side wall and the lower spacing wall,
wherein the cover hole includes:
an upper cover hole formed in the upper protruding wall; and
a lower cover hole formed in the lower protruding wall, and
wherein a size of the upper cover hole is greater than a size of the lower cover hole when viewed from a top.

14. The battery pack of claim 13,
wherein the reinforcement member includes:
an upper reinforcement member inserted into the upper extension space; and
a lower reinforcement member inserted into the lower extension space, and
wherein the upper reinforcement member and the lower reinforcement member define an upper reinforcing hole and a lower reinforcing hole configured to correspond to positions of the upper cover hole and the lower cover hole, and through which the fastening member passes, respectively.

15. The battery pack of claim 12,
wherein the middle end plate further includes:
middle protruding walls protruding from an upper end and a lower end of the middle spacing wall, extending to the second side wall, and defining a middle extension space together with the second side wall and the middle spacing wall, and
wherein the middle hole is formed in the middle protruding walls.

16. The battery pack of claim 15,
wherein the reinforcement member includes a middle reinforcement member inserted into the middle extension space, and
wherein the middle reinforcement member defines a middle reinforcing hole configured to correspond to a position of the middle hole, and through which the fastening member passes.

17. The battery pack of claim 1, wherein a thickness of the reinforcement member is smaller than a thickness of the end plate when viewed in the second direction.

18. The battery pack of claim 1,
wherein the end plate is formed of aluminum, and
wherein the reinforcement member is formed of steel.

19. The battery pack of claim 2,
wherein the battery module includes:
a first battery module; and
a second battery module spaced apart from the first battery module in the first direction,
wherein the end plate includes:
a cover end plate including a first side wall supporting one surface of the first battery module, which faces the second battery module, and an upper spacing wall spaced apart from the first side wall and defining an upper extension space with the first side wall, and a lower spacing wall spaced apart from the first side wall and defining a lower extension space with the first side wall, wherein the upper extension space and the lower extension space are spaced apart from each other in an upward and downward direction in an interior of the battery pack; and
a middle end plate including a second side wall supporting one surface of the second battery module, which faces the first battery module, and a middle spacing wall spaced apart from the second side wall and defining a middle extension space between the upper extension space and the lower extension space with the second side wall, and
wherein the middle spacing wall is disposed to be inserted between the upper spacing wall and the lower spacing wall.
